(19) United States
(12) Patent Application Publication
(10) Pub. No.: US 2020/0210172 A1
(43) Pub. Date: Jul. 2, 2020

(54) DYNAMIC CONFIGURATION OF A DATA FLOW ARRAY FOR PROCESSING DATA FLOW ARRAY INSTRUCTIONS

(71) Applicant: Intel Corporation, Santa Clara, CA (US)

(72) Inventors: Michael ESPIG, Newberg, OR (US); Matthew C. MERTEN, Hillsboro, OR (US); Sean MIRKES, Beaverton, OR (US)

(21) Appl. No.: 16/233,650

(22) Filed: Dec. 27, 2018

(51) Int. Cl. G06F 9/22; G06F 9/445; G06F 9/54

(52) U.S. Cl. CPC G06F 9/226; G06F 9/546; G06F 9/44578; G06F 9/223

(57) ABSTRACT

A system for processing data flow array instructions is described. The system includes a data flow array, which includes a plurality of processing elements; a decoder to receive a data flow array instruction and generate a set of microinstructions based on the data flow array instruction; a reservation station to receive and dispatch each microinstruction in the set of microinstructions, wherein the set of microinstructions includes a configuration microinstruction for configuring the data flow array for processing the data flow array instruction; a configuration watcher to receive the configuration microinstruction and to add a configuration identifier and a set of parameters of the configuration microinstruction to a configuration queue for the data flow array, wherein the data flow array is to configure the plurality of processing elements based on configuration information associated with the configuration identifier and the set of parameters.

### FIELD OF INVENTION

The field of the invention relates generally to processing instructions by a data flow array. More specifically, the field of the invention relates to dynamically configuring a data flow array to process data flow array instructions.

### BACKGROUND

A data flow array is comprised of a set of processing elements that are each associated with a set of operations. For example, each of the processing elements in a data flow array may be configured to perform one of an addition operation, a multiplication operation, a shifting operation, etc. Each processing element includes a set of inputs, which are used for performing a corresponding operation, and a set of outputs, which correspond to the results of the operation using the set of inputs. The processing elements are coupled together via routing channels such that outputs of one processing element can serve as inputs to one or more other processing elements in the data flow array.

Data flow arrays offer high degrees of performance by allowing multiple processing elements to operate simultaneously on different aspects of a function or a larger operation (e.g., different sets of processing elements can simultaneously perform different portions of the same or different iterations of a programming loop). Accordingly, data flow arrays can perform more operations per cycle than many other systems. However, despite some performance benefits, traditional systems that utilize data flow arrays suffer from some inefficiencies. For example, data flow arrays are typically statically configured for a particular objective/function. For instance, a data flow array may be configured to perform a particular programming loop. In this example, the data flow array can only be utilized for performing iterations of the programming loop. Accordingly, a single data flow array may have limited usefulness for a piece of software code when only one objective/function can be processed by the array.

### BRIEF DESCRIPTION OF THE DRAWINGS

Embodiments of the present invention are illustrated by way of example and not limitation in the figures of the accompanying drawings, in which like references indicate similar elements and in which:

FIG. 1A shows a data flow array (DFA) for supporting processing by a set of processing elements, according to one example embodiment.

FIG. 1B shows a DFA with operations assigned to each processing element, according to one example embodiment.

FIG. 2 shows a processing element with a set of processing element inputs and a set of processing element outputs, according to one example embodiment.

FIG. 3 shows a processing system, including a DFA, according to one example embodiment.

FIG. 4 shows an example DFA instruction definition for a DFA instruction, including a corresponding set of microinstructions, according to one example embodiment.

FIGS. 5A and 5B show a method for processing DFA instructions, according to one example embodiment.

FIG. 6 is a block diagram of a processor that may have more than one core, may have an integrated memory controller, and may have integrated graphics according to example embodiment.

FIG. 7 shown a block diagram of a system according to example embodiment.

FIG. 8 is a block diagram of a first more specific exemplary system according to example embodiment.

FIG. 9 is a block diagram of a second more specific exemplary system according to example embodiment.

FIG. 10 is a block diagram of a System-on-a-Chip (SoC) according to example embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

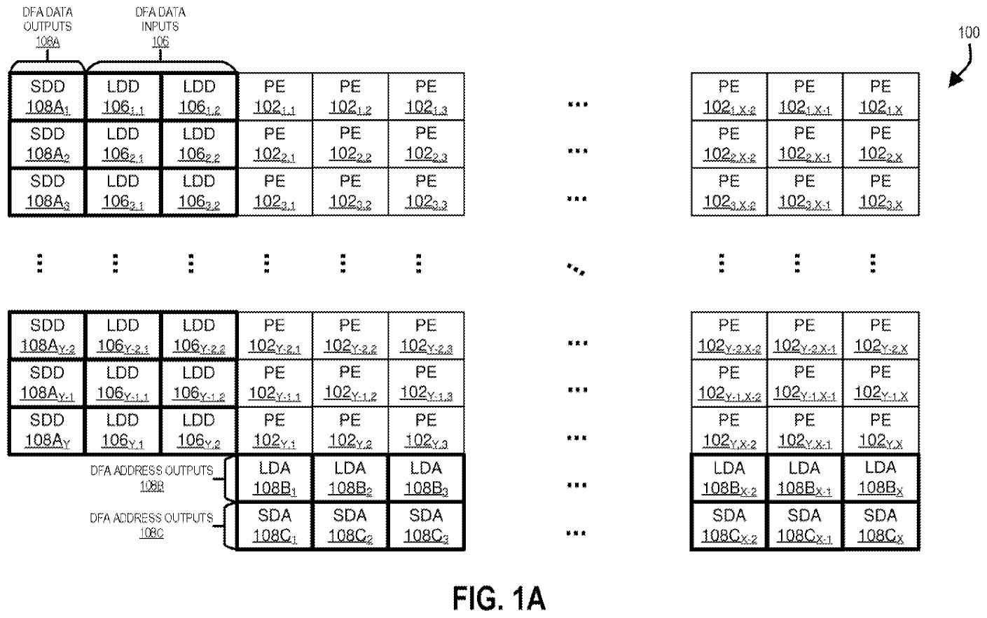

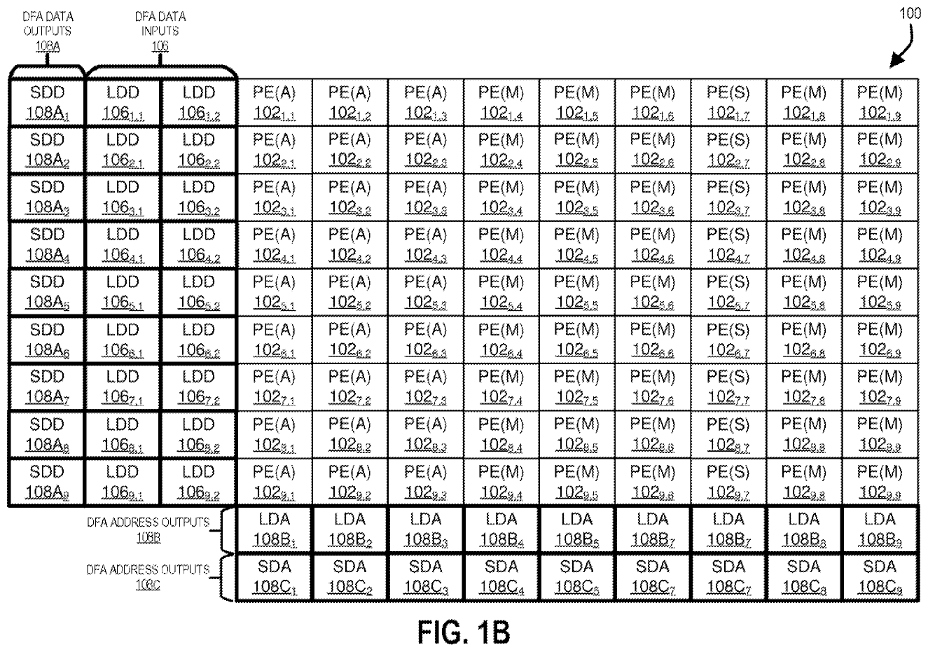

FIG. 1A shows a data flow array (DFA) 100 for supporting processing by a set of processing elements 102, according to one example embodiment. In particular, the DFA 100 includes an array of processing elements 102_{1,1}-102_{Y,X} that each may receive a set of DFA data inputs 106 from memory (sometimes referred to as LDDs 106) and the DFA 100 may emit a set of DFA data outputs 108A-108C to memory (sometimes referred to as SDDs 108A, LDAs 108B, and SDAs 108C, respectively). As used herein the DFA inputs 106 are used for inputting values into the DFA 100 and the DFA outputs 108 are used for outputting values from the DFA 100. For example, the processing element 102_{1,1} may be logically coupled to DFA data inputs 106_{1,1} and 106_{1,2} (e.g., locations in memory) which are used by the processing element 102_{1,1} to perform an operation to produce the DFA data output 108A₁. In contrast, the processing element 102_{1,1} may produce an address that is sent to the DFA address output 108B₁ and data returns from memory corresponding to the address from DFA data input 106_{1,1} and may be fed to processing element 102_{1,2}. In another example, the processing element 102_{2,1} can compute an address for a store data value that is computed by processing element 102_{2,2} and the processing elements 102_{2,1} and 102_{2,2} feed DFA data output 108C₂ and DFA data output 108A₂, respectively. Accordingly, each of the DFA inputs 106 and DFA outputs 108 may be configured to be used by any of the processing elements 102 of the DFA 100.

In one embodiment, each of the processing elements 102_{1,1}-102_{Y,X} of the DFA 100 may each be selected to perform an operation of an arithmetic logic unit (ALU) (e.g., an addition operation, a multiplication operation, a shift operation, or a logic operation) and/or an operation of a floating-point unit. For example, as shown in FIG. 1B, each of the processing elements 102_{1,1}-102_{9,9} are assigned to either an addition operation (i.e., PE(A)), a multiplication operation (i.e., PE(M)), or a shift operation (i.e., PE(S)). As will be described below, configuration/assignment of the processing elements 102 to an operation type is configurable during execution of a set of instructions. In particular, during execution of a first instruction by the DFA 100, a processing element 102 is configured to perform a first operation (e.g., an addition operation) but during execution of a second instruction, the processing element 102 is configured to perform a second operation (e.g., a shift operation).

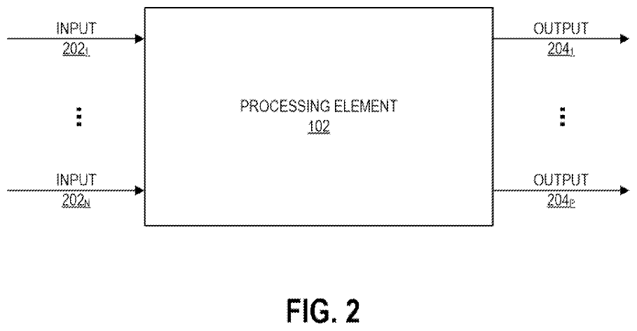

Each of the processing elements 102 includes a set of one or more processing element inputs and a set of one or more processing element outputs. For example, FIG. 2 shows a processing element 102 with a set of processing element inputs 202 and a set of processing element outputs 204. The processing element inputs 202 of each processing element 102 may be coupled to a DFA input 106, an input queue that receive inputs from register files, or the processing element output 204 of another processing element 102. Accordingly, each processing element 102 may be either configured to receive inputs from outside the DFA 100 (e.g., via the DFA inputs 106 or an input queue that receive inputs from register files) or from inside the DFA 100 (i.e., via an output 204 of another processing element 102). Although described as input queues and DFA inputs 106 being separate inputs into the DFA 100, the inputs queues may be implemented using the DFA inputs 106 but without the need for the DFA array 100 to generate corresponding addresses using the outputs 108 as the data does not come from memory.

Each of the processing elements 102 may be connected via a set of routing channels such that outputs 204 from one processing element 102 may feed an input 202 of another processing element 102. For example, a local network of routing channels may be used for connecting adjacent processing elements 102 while a global network of routing channels may be used for connecting remote processing elements 102 to each other. The processing elements 102 are data driven such that as a processing element 102 receives inputs 202, the processing element 102 is triggered to perform a respective operation to produce the outputs 204. As will be described herein, sets of processing elements 102 may be coupled together to perform a function, instruction, or another objective. For example, a first configuration of the DFA 100 may be used for performing a programming loop where each pass of data from the inputs 106 of the DFA 100 to the outputs 108 of the DFA 100 constitutes an iteration of the programming loop. In another example, a second configuration of the DFA 100 may be used for performing an instruction in which a single pass of data from the inputs 106 of the DFA 100 to the outputs 108 of the DFA 100 constitutes performance of the instruction.

As described above, the processing elements 102 of the DFA 100 (1) are data driven such that they begin performing corresponding operations upon receipt of inputs 202 (either from DFA inputs 106, an input queue that receive inputs from register files, or from outputs 204 of other processing elements 102), (2) do not require use of separate memory elements (e.g., registers) to store/pass inputs to processing elements 102 (e.g., processing elements 102 may directly pass outputs 204 to inputs 202 of other processing elements 102), and (3) exhibit exceptional parallelism by allowing processing elements 102 to work simultaneously to perform separate operations for a common function/objective (e.g., an instruction or programming loop). In this fashion, the DFA 100 allows performance of many more operations per cycle in comparison to other processing techniques.

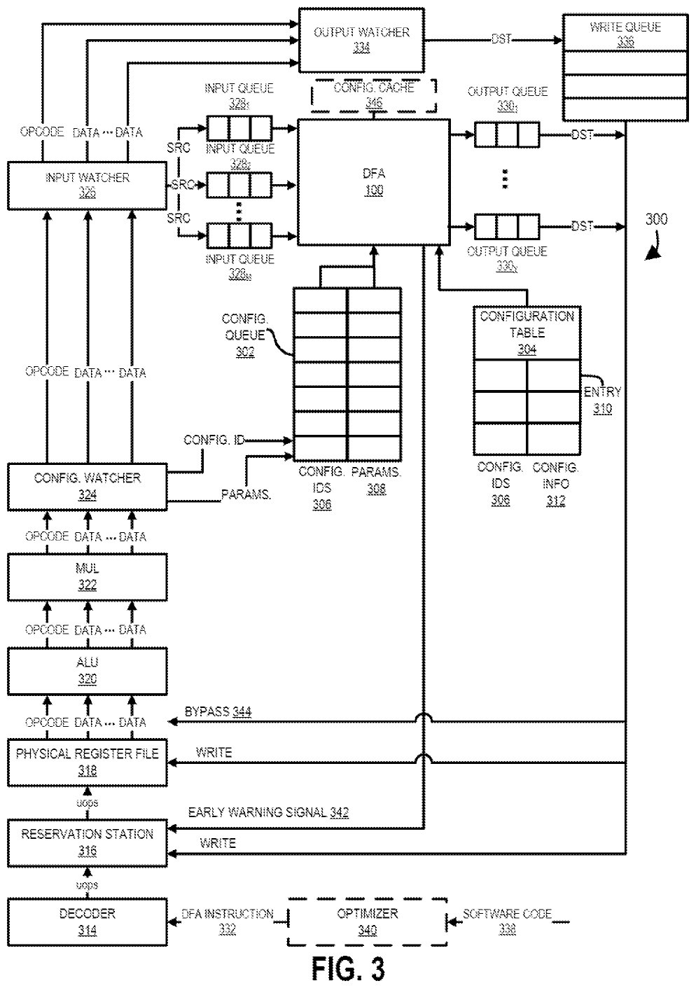

FIG. 3 shows a processing system 300, including a DFA 100, according to one example embodiment. In some embodiments, the processing system 300 may be integrated into a core of a processor and may be used for dynamically executing one or more DFA instructions 332 (i.e., instructions processed by the DFA 100) or non-DFA instructions for corresponding software code 338 being processed by the processing system 300. The DFA instructions 332 may perform mathematical operations, bit manipulations, programming loops, etc. As shown in FIG. 3, the processing system 300 includes a configuration queue 302 and a configuration table 304. The configuration queue 302 is a first-in-first-out (FIFO) queue, which includes pairs of (1) configuration identifiers 306 and (2) sets of parameters 308. The configuration identifiers 306 correspond to entries 310 in the configuration table 304 and each entry 310 in the configuration table 304 includes configuration information 312 for configuring the DFA 100 to perform a DFA instruction.

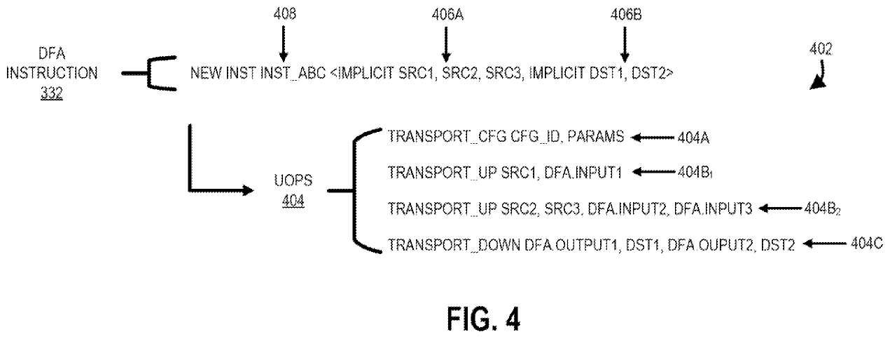

FIG. 4 shows an example DFA instruction definition 402 for a DFA instruction 332, including a corresponding set of microinstructions 404 (sometimes referred to as microoperations 404 or uops 404), according to one example embodiment. As shown in FIG. 4, the DFA instruction definition 402 includes an instruction name 408 (e.g., INST_ABC), a set of source operands 406A (i.e., SRC1, SRC2, and SRC3), and a set of destination operands 406B (e.g., DST1) for the DFA instruction 332. For example, the set of source operands 406A and the set of destination operands 406B may correspond to registers in a register file (e.g., EAX, EBX, ECX, EDX, and/or ESI registers) and may be implicitly indicated (as shown in FIG. 4) (e.g., specific logical source required to be used but not specified in the instruction encoding) or explicitly indicated (e.g., configurable logical source required to be specified in the instruction encoding). In particular, when the instruction 332 is called in the software code 338, corresponding sets of registers may be explicitly indicated (e.g., INST_ABC ESI, EAX, ECX) in the instruction call.

In response to the DFA instruction 332, the set of microinstructions 404 are generated by a decoder 314 of the processing system 300 and are passed to the reservation station 316 (i.e., a scheduler of the processing system 300). The set of microinstructions 404 includes a transport configuration microinstruction 404A (i.e., TRANSPORT_CFG) with a configuration identifier 306 (i.e., CFG_ID) and a set of parameters 308 (i.e., PARAMS). In response to receipt of the transport configuration microinstruction 404A, the reservation station 316 begins to dispatch the microinstruction 404A, including retrieving any necessary information (e.g., the set of parameters 308) for the transport configuration microinstruction 404A from the physical register (after mapping a set of logical registers to the physical registers that hold the values) file 318 and passing the transport configuration microinstruction 404A up the execution stack of the processing system 300. The transport configuration microinstruction 404A bypasses the processing units in the execution stack that are not intended for the transport configuration microinstruction 404A (e.g., bypasses the ALU 320 and the MUL 322) and is consumed/processed by the configuration watcher 324. In particular, the ALU 320, the MUL 322, and the configuration watcher 324 snoop microinstructions, including opcodes and source operands, on a shared set of wires/buses and each unit processes only those microinstructions 404 with opcodes that they are assigned (e.g., the ALU 320 is assigned opcodes for addition and subtraction, the MUL 322 is assigned opcodes for multiplication, and the configuration watcher 324 is assigned opcodes for transport configuration). Accordingly, a transport configuration opcode associated with the transport configuration microinstruction 404A is ignored by the ALU 320 and the MUL 322 but is processed/consumed by the configuration watcher 324. In particular, in response to the transport configuration microinstruction 404A, the configuration watcher 324 adds the configuration identifier 306 and set of parameters 308 of the transport configuration microinstruction 404A to the bottom/end of the configuration queue 302.

The DFA 100 retrieves a configuration identifier 306 and a corresponding set of parameters 308 from the top/head of the configuration queue 302 and configures the DFA 100 based on the configuration identifier 306 and a corresponding set of parameters 308. For example, the configuration information 312 in the configuration table 304 may include one or more of (1) processing element 102 types and (2) routing channel information. In this example, the processing element 102 types indicate what operation one or more processing elements 102 in the DFA 100 should perform (e.g., an addition operation, a multiplication operation, a shift operation, a logic operation, etc.), while the routing channel information indicates routing channels between processing elements 102 in the DFA 100 and routes to DFA inputs 106 and DFA outputs 108 and input queues 328 and output queues 330. Accordingly, in response to the DFA instruction 332, a transport configuration microinstruction 404A is generated with a configuration identifier 306 corresponding to the instruction 402 and an optional set of parameters 308 (e.g., constants to be used by processing elements 102 of the DFA 100). The microinstruction 404A adds the configuration identifier 306 corresponding to the instruction 402 and the set of parameters 308 to the configuration queue 302. When the configuration identifier 306 and the set of parameters 308 move to the top/head of the configuration queue 302, the DFA 100 accepts the configuration identifier 306 and the set of parameters 308 and the DFA 100 configures itself with (1) the configuration information 312 from the configuration table 304 corresponding to the configuration identifier 306 and (2) the set of parameters 308. The processing elements 102 of the DFA 100 thereafter await inputs from input queues 328 to become available, as will be described in greater detail below, such that corresponding operations of the processing elements 102 can commence.

In some embodiments, the configuration table 304 is loaded with configuration information 312 by the software code 338. For example, the software code 338 may include a load instruction prior to calling the corresponding DFA instruction 332, which loads configuration information 312 into the configuration table 304.

As shown in FIG. 3, the processing units in the execution stack snoop opcodes and data. As used herein, the data and number of data elements is relative to the microinstruction 404. For example, the data for a transport configuration microinstruction 404A is a configuration identifier and a set of parameters. However, data for other microinstructions 404 may be values for source operands, addresses for destination operands, etc.

As shown in FIG. 4, the set of microinstructions 404 includes a set of transport up microinstructions 404B (i.e., TRANSPORT_UP 404B₁ and 404B₂), which each include a reference/indication of one or more source operands in the set of source operands 406A of the DFA instruction 332 and corresponding inputs of the DFA 100. The transport up microinstructions 404B (sometimes referred to as transport input microinstructions 404B or input microinstructions 404B) may be used for loading source operands 406A into corresponding inputs of the DFA 100. For example, the processing system 300 may include an input watcher 326 and a set of input queues 328₁-328_{M} that correspond to inputs to the DFA 100. Similar to the transport configuration microinstruction 404A, in response to receipt of a transport up microinstruction 404B, the reservation station 316 begins to dispatch the microinstruction 404B, including retrieving any necessary information (e.g., the source operands 406A) for the transport up microinstruction 404B from the physical register file 318 and passing the transport up microinstruction 404B, including opcode and source operand values, up the execution stack of the processing system 300. The transport up microinstruction 404B bypasses the processing units in the execution stack that are not intended for the transport up microinstruction 404B (e.g., bypasses the ALU 320, the MUL 322, and the configuration watcher 324) and is consumed/processed by the input watcher 326 (i.e., the input watcher 326 is assigned the opcode of the transport up microinstruction 404B such that all transport up microinstructions 404B are consumed/processed by the input watcher 326).

In response to a transport up microinstructions 404B, the input watcher 326 adds the source operands 406A of the transport up microinstruction 404B to the bottom/end of the corresponding input queue 328. For example, the transport up microinstruction 404B₁ includes a first source operand (i.e., a value of the register or memory location indicated in SRC1), which may have been retrieved from a register of the physical register file 318, and an immediate operand (i.e., DFA.INPUT1) that indicates which input of the DFA 100 the first source operand is to be placed. For instance, the DFA.INPUT1 immediate operand may correspond to data input 106_{1,1}, which corresponds to input queue 328₁. Accordingly, in response to the transport up microinstruction 404B₁ the input watcher 326 places the first source operand (i.e., a value of the register or memory location indicated in SRC1) at the bottom/end of the input queue 328₁. In comparison, the transport up microinstruction 404B₂ includes a second source operand (i.e., a value of the register or memory location indicated in SRC2), a third source operand (i.e., a value of the register or memory location indicated in SRC3), both of which may have been retrieved from a register of the physical register file 318, and a set of immediate operands (i.e., DFA.INPUT2 and DFA.INPUT3) that indicate which input of the DFA 100 the second and third source operand are to be placed. For instance, the DFA.INPUT2 immediate operand may correspond to data input 106_{2,1}, which corresponds to input queue 328₂, and the DFA.INPUT3 immediate operand may correspond to data input 106_{3,2}, which corresponds to input queue 328_{M}. Accordingly, in response to the transport up microinstruction 404B₂ the input watcher 326 places the second source operand (i.e., a value of the register or memory location indicated in SRC2) at the bottom/end of the input queue 328₂ and the third source operand (i.e., a value of the register or memory location indicated in SRC3) at the bottom/end of the input queue 328_{M}.

As described above, upon processing of the transport configuration microinstruction 404A the DFA 100 has been configurated for the indicated DFA instruction 332. Further, upon processing the set of transport up microinstructions 404B, inputs 106/202 are available for the DFA 100. Accordingly, corresponding processing elements 102 in the DFA 100 may begin performing respective operations to produce outputs 204 that may be used as inputs 202 for other processing elements 102 or may correspond to a result of the DFA instruction 332 that are stored in the outputs 108 and/or the output queues 330.

As shown in FIG. 4, the set of microinstructions 404 includes a transport down microinstruction 404C (i.e., TRANSPORT_DOWN 404C), which includes a reference/indication of one or more destination operands in the set of destination operands 406B of the DFA instruction 332 and corresponding outputs 108 of the DFA 100. The transport down microinstruction 404C (sometimes referred to as a transport output microinstruction 404C or and output microinstruction 404C) may be used for loading values of outputs 108 of the DFA 100 into corresponding registers of the physical register file 318 as indicated by the set of destination operands 406B. For example, the processing system 300 may include an output watcher 334 and a write queue 336. In response to receipt of a transport down microinstruction 404C, the reservation station 316 will begin to dispatch the microinstruction 404C, including retrieving any necessary information for the transport down microinstruction 404C from the physical register file 318 and passing the transport down microinstruction 404C, including opcode and the set of destination operands 406B, up the execution stack of the processing system 300. The transport down microinstruction 404C bypasses the processing units in the execution stack that are not intended for the transport down microinstruction 404C (e.g., bypasses the ALU 320, the MUL 322, the configuration watcher 324, and the input watcher 326) and is consumed/processed by the output watcher 334 (i.e., the output watcher 334 is assigned the opcode of the transport down microinstruction 404C such that all transport down microinstructions 404C are consumed/processed by the output watcher 334).

In response to a transport down microinstruction 404C, the output watcher 334 moves the set of destination operands 406B of the transport down microinstruction 404C to the bottom/end of the write queue 336. For example, the transport down microinstruction 404C includes a destination operand (i.e., DST1), which may correspond to a register in the physical register file 318 or a memory location, and an immediate operand (i.e., DFA.OUTPUT1) that indicates which output 108 of the DFA 100 and corresponding output queue 330 a value is to be retrieved for the destination operand. In particular, each of the outputs 108 of the DFA 100 may be associated with a corresponding output queue 330₁-330_{Y} such that outputs 108 of the DFA 100 are added to the end of a corresponding output queue 330₁-330_{Y}. In the example of FIG. 4, the DFA.OUTPUT1 immediate operand may correspond to data input 108A₁, which may correspond to output queue 330₁. Accordingly, in response to the transport down microinstruction 404C, the output watcher 334 generates a write instruction to write the value at the front of the output queue 330₁ to the destination operand at the front of the write queue 336. For instance, the DFA 100 may process a set of source operands 406A that are loaded into the DFA 100 via the input queues 328 to generate a set of outputs 108 that are placed into the output queues 330. The values in the output queues 330 may await corresponding destination operands 406B in the write queue 336 such that write instructions can be generated for writing corresponding registers of the physical register file 318 or locations in memory.

Although shown and described as a plurality of microinstructions 404, in some embodiments, one or more of the transport configuration microinstruction 404A, the set of transport up microinstructions 404B, and/or the set of transport down microinstructions 404C may be combined into a fewer number of microinstructions 404. For example, (1) the transport configuration microinstruction 404A and the set of transport up microinstructions 404B may be included in a single microinstruction 404; (2) the set of transport up microinstructions 404B and the set of transport down microinstructions 404C may be included in a single microinstruction 404, (3) the transport configuration microinstruction 404A and the set of transport down microinstructions 404C may be included in a single microinstruction 404, or (4) the transport configuration microinstruction 404A, the set of transport up microinstructions 404B, and the set of transport down microinstructions 404C may be included in a single microinstruction 404.

After writing the outputs 108 of the DFA 100 to the physical register file 318, the corresponding values in the physical register file 318 can be used for one or more other additional instructions (e.g., other DFA instructions or non-DFA instructions). For example, the values in the physical register file 318 written in response to the DFA instruction 332 can be used for a multiplication instruction. In one embodiment, the DFA 100 may emit an early warning signal 342 to the reservation station 316 to ensure any corresponding subsequent instruction/microinstruction is ready for execution once corresponding operands for the instruction/microinstruction are available. In particular, the reservation station 316 ensures that operands for an instruction/microinstruction are available before sending the instruction up the execution stack. However, if the reservation station 316 waits for operands from the DFA 100 (i.e., outputs 108 of the DFA 100 that are used as operands for another instruction) to be written to the physical register file 318, processing of the instruction will be delayed several cycles while the reservation station 316 begins the dispatch process after the write is complete. Accordingly, the early warning signal 342 informs the reservation station 316 that a set of outputs will be imminently written to the physical register file 318 (e.g., written in an indicated or predefined number of cycles). If the reservation station 316 is awaiting the registers for a corresponding instruction, the reservation station 316 can preemptively dispatch the instruction any time after receipt of the early warning signal 342 such that the instruction will meet the inputs en route to a corresponding execution unit (i.e., the ALU 320, MUL 322, configuration watcher 324, etc.). In some embodiments, the write queue 336 can provide the outputs 108 via a bypass 344, such that the operands of the next instruction are available following dispatch from the reservation station 316 and prior to processing by the execution stack. In some embodiments, the bypass 344 can be provided to one or more units in the execution stack (e.g., the ALU 320, MUL 322, etc.).

As described above, the DFA 100 may be configured by corresponding microinstructions 404 of a DFA instruction 322 and execution units of the processing system 300 (e.g., the configuration watcher 324, configuration queue 302, configuration table 304, input watcher 326, input queues 328, output watcher 334, output queues 330, write queue 336, etc.). In this fashion, the software code 338 can utilize multiple different DFA instructions 332 and the DFA 100 can be configured during execution for each of these different DFA instructions. In particular, as DFA instructions 332 are being processed, corresponding configuration identifiers 306 and parameters 308 are added to the configuration queue 302 for configuring the DFA 100 for this particular DFA instruction. Further, input operands for the DFA instruction 332 are added to input queues 328 such that upon configuration of the DFA 100, the input operands are available for processing by corresponding processing elements 102. Lastly, output operands for the DFA instruction 332 are added to the output queues 330 such that outputs 108 of the DFA 100 may be written to the output operands once available. This synchronization between queues allows the processing of different DFA instructions 332 dynamically by the DFA 100.

In some embodiments, a programmer/user may manually define (e.g., determine/indicate a set of microinstructions 404 and the configuration information 312 for a DFA instruction 332) and call a DFA instruction 332 in the software code 338. For example, configuration information 312 may be manually generated and imported into the software code 338. Alternatively, or in addition to this manual definition and usage of DFA instructions 332, an optimizer 340 may examine the software code 338 and determine possible use of one or more DFA instructions 332. For example, the DFA 100 may be particularly suited for performance of a programming loop as the DFA 100 can perform multiple operations of the programming loop simultaneously, including possibly performing operations of separate iterations of the programming loop simultaneously. Accordingly, in response to detecting a programming loop in the software code 338, the optimizer 340 may determine that a DFA instruction 332 may improve execution performance of the software code 338 and consequently generate (1) configuration information 312 for a new DFA instruction 332, (2) a DFA instruction definition 402 for the DFA instruction 332, and (3) add or otherwise replace the programming loop in the software code 338 with a call to the DFA instruction 332, such that the processing system 300 can process the new DFA instruction 332 as described above with the DFA 100.

In some embodiments, the DFA 100 and/or the processing system 300 may include a configuration cache 346 for caching one or more pieces of information related to a previous invocation/iteration of a DFA instruction 332 for later use. For example, the software code 338 may include or the optimizer may determine that a particular DFA instruction 332 should be processed by the DFA 100 and in response transmit a corresponding set of microinstructions 404 for the DFA instruction 332 to the execution stack (e.g., a transport configuration microinstruction 404A, a set of transport up microinstructions 404B, and a set of transport down microinstructions 404C). In response to this first invocation/iteration of the DFA instruction 332, the DFA 100 may cause the configuration cache 346 to store one or more of (1) configuration information 312 associated with the DFA instruction 332 and the transport configuration microinstruction 404A, (2) parameters 308 from the transport configuration microinstruction 404A, and (3) the set of transport down microinstructions 404C or information from the set of transport down microinstructions 404C. In response to the software code 338 including the same DFA instruction 332 or the optimizer determining that the same DFA instruction 332 should be performed again (possibly with different inputs), a reference to the entry in the configuration cache 346 may be transmitted to the DFA 100 and/or the configuration cache 346 such that the information from the original invocation of the DFA instruction 332 is utilized for this subsequent invocation of the DFA instruction 332 and without the need to generate and/or transmit each microinstruction 404 in the set of microinstructions 404. For example, in response to a second invocation of a DFA instruction 332 (where the first invocation of the DFA instruction 332 caused the configuration cache 346 to store one or more pieces of information associated with the DFA instruction 332), the decoder 314 may transmit to the execution stack a transport configuration microinstruction 404A, including the configuration identifier 306 and optionally parameters 308, and a set of transport up microinstructions 404B. The DFA 100 may utilize one or more of (1) configuration information 312 associated with the DFA instruction 332, (2) the parameters 308 from the preceding transport configuration microinstruction 404A, and (3) the set of transport down microinstructions 404C from the preceding invocation of the DFA instruction 332 that are stored in the configuration cache 346. Accordingly, during a subsequent invocation/iteration of a DFA instruction 332, a reduced set of information/microinstructions 404 may be transmitted up the execution stack for processing.

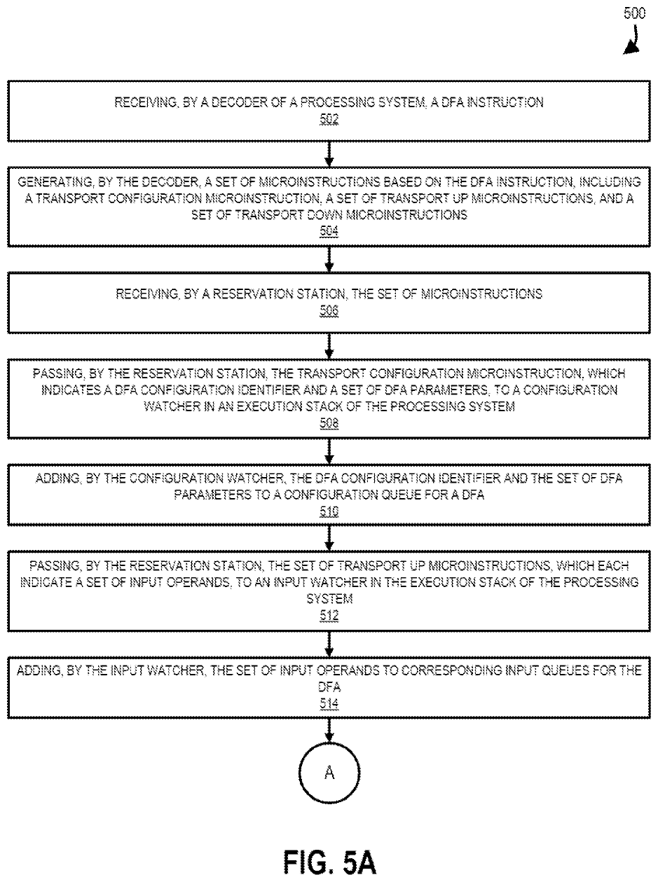

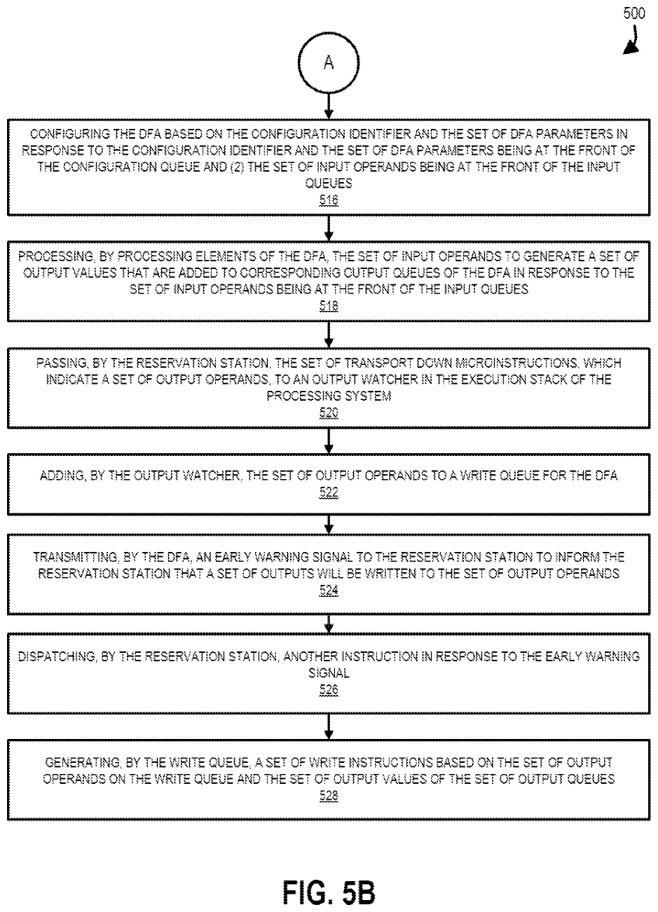

Turning now to FIGS. 5A and 5B, a method 500 will be described for processing DFA instructions 332, according to one example embodiment. The operations in the flow diagram will be described with reference to the exemplary embodiments of the other figures. However, it should be understood that the operations of the flow diagram can be performed by embodiments other than those discussed with reference to the other figures, and the embodiments discussed with reference to these other figures can perform operations different than those discussed with reference to the flow diagrams. In some embodiments, operations of the method 500 may be performed in partially or fully overlapping time periods.

As shown in FIG. 5A, the method 500 may commence at operation 502 with the decoder 314 of the processing system 300 receiving a DFA instruction 332. As described above, the DFA instruction 332 may be part of the software code 338 that is being processed by the decoder 314. In some embodiments, the optimizer 340 may analyze the software code 338 and may determine that a set of instructions existing in the software coder 338 may be better served through processing by the DFA 100 of the processing system 300. In this embodiment, the optimizer 340 may define the DFA instruction 332 (e.g., the DFA instruction definition 402 and/or configuration information 312) and pass a call to the DFA instruction 332 to the decoder 314 at operation 502.

At operation 504, the decoder 314 generates a set of microinstructions 404 based on the DFA instruction 332, including a transport configuration microinstruction 404A, a set of transport up microinstructions 404B, and a set of transport down microinstructions 404C, and the reservation station 316 receives the microinstructions 404 from the decoder 314 at operation 506. As described above and as will be used in the method 500, the set of microinstructions 404 are used for configuring the DFA 100 for the DFA instruction 332.

At operation 508, the reservation station 316 passes the transport configuration microinstruction 404A, which indicates a DFA configuration identifier 306 and a set of DFA parameters 308, to a configuration watcher 324 in an execution stack of the processing system 300 such that the configuration watcher 324 can add the DFA configuration identifier 306 and the set of DFA parameters 308 to the configuration queue 302 for the DFA 100 at operation 510.

At operation 512, the reservation station 316 passes the set of transport up microinstructions 404B, which each indicate a set of input operands 406A, to an input watcher 326 in the execution stack of the processing system 300 such that the input watcher 326 can add the set of input operands 406A to corresponding input queues 328 for the DFA 100 at operation 514.

At operation 516, the DFA 100 is configured based on the configuration identifier 306 and the set of DFA parameters 308 in response to the configuration identifier 306 and the set of DFA parameters 308 being at the front of the configuration queue 302 and (2) the set of input operands 406A being at the front of the input queues 328. In particular, the configuration queue 302 and the input queues 328 are synchronized such that (1) the configuration identifier 306 and the set of DFA parameters 308 and (2) the input operands 406A for the DFA instruction 332 are available together at the front of their respective queues 302/328. When this occurs, the DFA 100 can be configured for subsequent processing of the input operands 406A by the DFA 100. In particular, the processing elements 102 of the DFA 100 process the set of input operands 406A to generate a set of output values that are added to corresponding output queues 330 of the DFA 100 at operation at operation 518.

At operation 520, the reservation station 316 passes the set of transport down microinstructions 404C, which indicate a set of output operands 406C, to an output watcher 334 in the execution stack of the processing system 100 such that the output watcher 334 can add the set of output operands 406C to the write queue 336 for the DFA 100 at operation 522.

In some embodiments, the DFA 100 may transmit an early warning signal 342 to the reservation station 316 at operation 524 to inform the reservation station 316 that a set of outputs will be imminently (e.g., within an indicated or predefined time period) written to the set of output operands 406B. Accordingly, the reservation station 316 can dispatch another instruction at operation 526 that uses at least one operand from the set of output operands 406B in response to the early warning signal 342.

At operation 528, the write queue 336 generates a set of write instructions based on the set of output operands 406B in the write queue 336 and the set of output values of the set of output queues 300. In particular, the write instructions may be used for writing the set of output operands 406B of the physical register file 318 or otherwise making the set of output values of the set of output queues 300 available for a subsequent instruction being processing by the processing system 300.

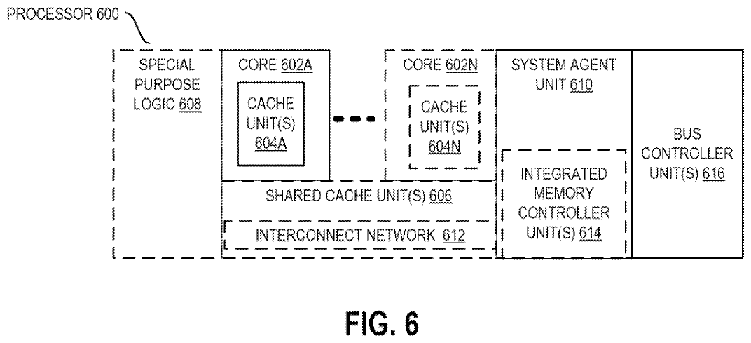

FIG. 6 is a block diagram of a processor 600 that may have more than one core, may have an integrated memory controller, and may have integrated graphics according to embodiments of the invention. The solid lined boxes in FIG. 6 illustrate a processor 600 with a single core 602A, a system agent 610, a set of one or more bus controller units 616, while the optional addition of the dashed lined boxes illustrates an alternative processor 600 with multiple cores 602A-N, a set of one or more integrated memory controller unit(s) 614 in the system agent unit 610, and special purpose logic 608.

Thus, different implementations of the processor 600 may include: 1) a CPU with the special purpose logic 608 being integrated graphics and/or scientific (throughput) logic (which may include one or more cores), and the cores 602A-N being one or more general purpose cores (e.g., general purpose in-order cores, general purpose out-of-order cores, a combination of the two); 2) a coprocessor with the cores 602A-N being a large number of special purpose cores intended primarily for graphics and/or scientific (throughput); and 3) a coprocessor with the cores 602A-N being a large number of general purpose in-order cores. Thus, the processor 600 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 600 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 606, and external memory (not shown) coupled to the set of integrated memory controller units 614. The set of shared cache units 606 may include one or more mid-level caches, such as level 2 (L2), level 3 (L3), level 4 (L4), or other levels of cache, a last level cache (LLC), and/or combinations thereof. While in one embodiment a ring based interconnect unit 612 interconnects the integrated graphics logic 608 (integrated graphics logic 608 is an example of and is also referred to herein as special purpose logic), the set of shared cache units 606, and the system agent unit 610/integrated memory controller unit(s) 614, alternative embodiments may use any number of well-known techniques for interconnecting such units. In one embodiment, coherency is maintained between one or more cache units 606 and cores 602A-N.

In some embodiments, one or more of the cores 602A-N are capable of multi-threading. The system agent 610 includes those components coordinating and operating cores 602A-N. The system agent unit 610 may include for example a power control unit (PCU) and a display unit. The PCU may be or include logic and components needed for regulating the power state of the cores 602A-N and the integrated graphics logic 608. The display unit is for driving one or more externally connected displays.

The cores 602A-N may be homogenous or heterogeneous in terms of architecture instruction set; that is, two or more of the cores 602A-N may be capable of execution the same instruction set, while others may be capable of executing only a subset of that instruction set or a different instruction set.

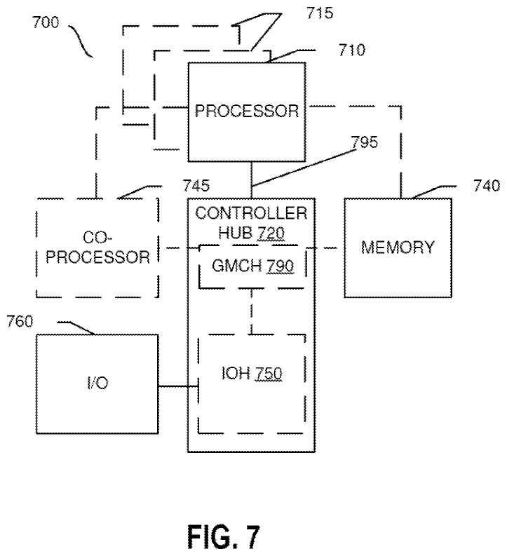

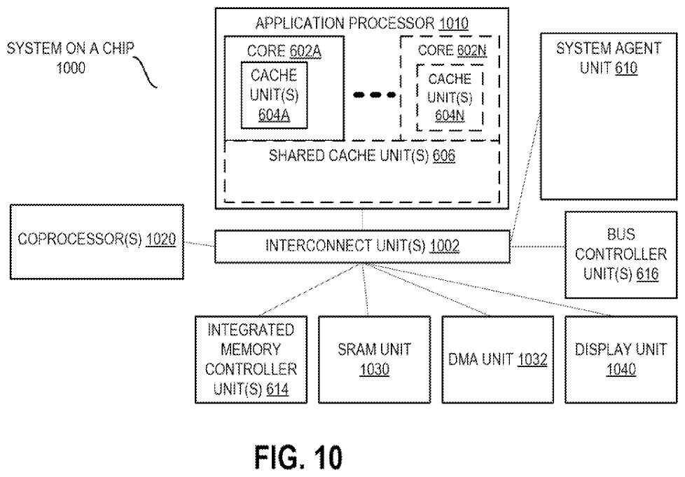

FIGS. 7-10 are block diagrams of exemplary computer architectures that may be used to implement the embodiments described herein. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 7, shown is a block diagram of a system 700 in accordance with one embodiment of the present invention. The system 700 may include one or more processors 710, 715, which are coupled to a controller hub 720. In one embodiment, the controller hub 720 includes a graphics memory controller hub (GMCH) 790 and an Input/Output Hub (IOH) 750 (which may be on separate chips); the GMCH 790 includes memory and graphics controllers to which are coupled memory 740 and a coprocessor 745; the IOH 750 couples input/output (I/O) devices 760 to the GMCH 790. Alternatively, one or both of the memory and graphics controllers are integrated within the processor (as described herein), the memory 740 and the coprocessor 745 are coupled directly to the processor 710, and the controller hub 720 in a single chip with the IOH 750.

The optional nature of additional processors 715 is denoted in FIG. 7 with broken lines. Each processor 710, 715 may include one or more of the processing cores described herein and may be some version of the processor 600. In one embodiment, the processor 600 may be one of the processors 710 and 715.

The memory 740 may be, for example, dynamic random-access memory (DRAM), phase change memory (PCM), or a combination of the two. For at least one embodiment, the controller hub 720 communicates with the processor(s) 710, 715 via a multi-drop bus, such as a frontside bus (FSB), point-to-point interface such as QuickPath Interconnect (QPI), or similar connection 795.

In one embodiment, the coprocessor 745 is a special-purpose processor, such as, for example, a high-throughput MIC processor, a network or communication processor, compression engine, graphics processor, GPGPU, embedded processor, or the like. In one embodiment, controller hub 720 may include an integrated graphics accelerator.

There can be a variety of differences between the physical resources 710, 715 in terms of a spectrum of metrics of merit including architectural, microarchitectural, thermal, power consumption characteristics, and the like.

In one embodiment, the processor 710 executes instructions that control data processing operations of a general type. Embedded within the instructions may be coprocessor instructions. The processor 710 recognizes these coprocessor instructions as being of a type that should be executed by the attached coprocessor 745. Accordingly, the processor 710 issues these coprocessor instructions (or control signals representing coprocessor instructions) on a coprocessor bus or other interconnect, to coprocessor 745. Coprocessor(s) 745 accept and execute the received coprocessor instructions.

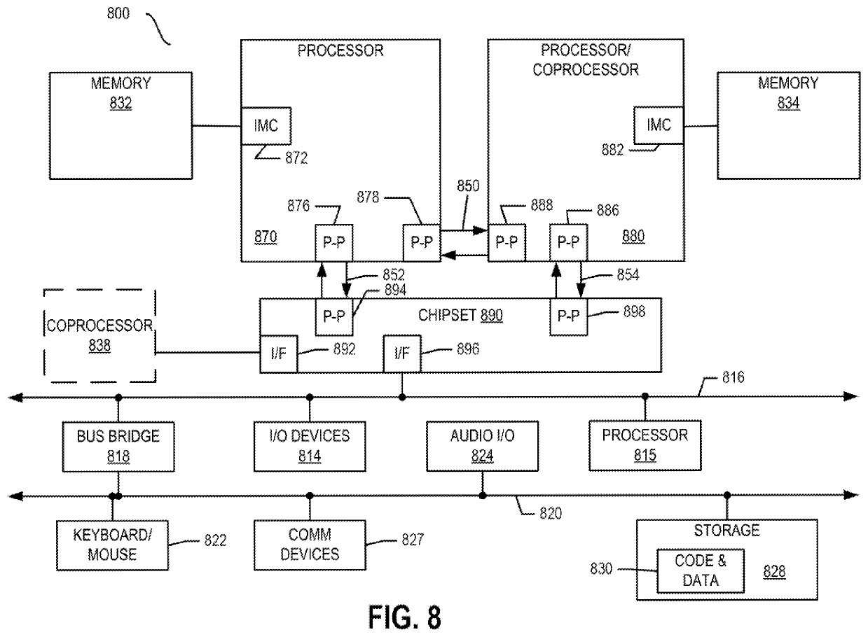

Referring now to FIG. 8, shown is a block diagram of a first more specific exemplary system 800 in accordance with an embodiment of the present invention. As shown in FIG. 8, multiprocessor system 800 is a point-to-point interconnect system, and includes a first processor 870 and a second processor 880 coupled via a point-to-point interconnect 850. Each of processors 870 and 880 may be some version of the processor 600. In one embodiment of the invention, processors 870 and 880 are respectively processors 710 and 715, while coprocessor 838 is coprocessor 745. In another embodiment, processors 870 and 880 are respectively processor 710 and coprocessor 745.

Processors 870 and 880 are shown including integrated memory controller (IMC) units 872 and 882, respectively. Processor 870 also includes as part of its bus controller units point-to-point (P-P) interfaces 876 and 878; similarly, second processor 880 includes P-P interfaces 886 and 888. Processors 870, 880 may exchange information via a point-to-point (P-P) interface 850 using P-P interface circuits 878, 888. As shown in FIG. 8, IMCs 872 and 882 couple the processors to respective memories, namely a memory 832 and a memory 834, which may be portions of main memory locally attached to the respective processors. In one embodiment, the processor 600 may be one of the processors 870 and 880.

Processors 870, 880 may each exchange information with a chipset 890 via individual P-P interfaces 852, 854 using point to point interface circuits 876, 894, 886, 898. Chipset 890 may optionally exchange information with the coprocessor 838 via a high-performance interface 892. In one embodiment, the coprocessor 838 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 890 may be coupled to a first bus 816 via an interface 896. In one embodiment, first bus 816 may be a Peripheral Component Interconnect (PCI) bus, or a bus such as a PCI Express bus or another third generation I/O interconnect bus, although the scope of the present invention is not so limited.

As shown in FIG. 8, various I/O devices 814 may be coupled to first bus 816, along with a bus bridge 818 which couples first bus 816 to a second bus 820. In one embodiment, one or more additional processor(s) 815, such as coprocessors, high-throughput MIC processors, GPGPU's, accelerators (such as, e.g., graphics accelerators or digital signal processing (DSP) units), field programmable gate arrays, or any other processor, are coupled to first bus 816. In one embodiment, second bus 820 may be a low pin count (LPC) bus. Various devices may be coupled to a second bus 820 including, for example, a keyboard and/or mouse 822, communication devices 827 and a storage unit 828 such as a disk drive or other mass storage device which may include instructions/code and data 830, in one embodiment. Further, an audio I/O 824 may be coupled to the second bus 820. Note that other architectures are possible. For example, instead of the point-to-point architecture of FIG. 8, a system may implement a multi-drop bus or other such architecture.

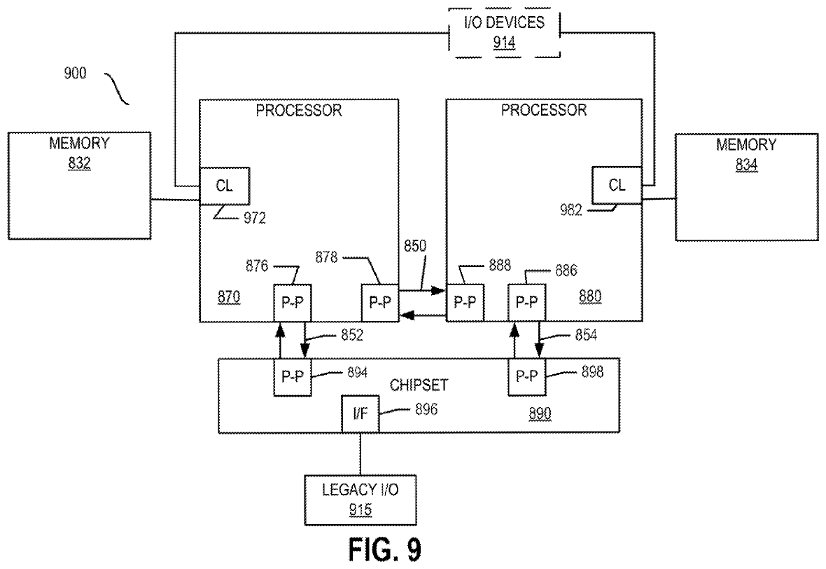

Referring now to FIG. 9, shown is a block diagram of a second more specific exemplary system 900 in accordance with an embodiment of the present invention. Like elements in FIGS. 8 and 9 bear like reference numerals, and certain aspects of FIG. 8 have been omitted from FIG. 9 in order to avoid obscuring other aspects of FIG. 9.

FIG. 9 illustrates that the processors 870, 880 may include integrated memory and I/O control logic (“CL”) 972 and 982, respectively. Thus, the CL 972, 982 include integrated memory controller units and include I/O control logic. FIG. 9 illustrates that not only are the memories 832, 834 coupled to the CL 972, 982, but also that I/O devices 914 are also coupled to the control logic 972, 982. Legacy I/O devices 915 are coupled to the chipset 890.

Referring now to FIG. 12, shown is a block diagram of a SoC 1200 in accordance with an embodiment of the present invention. Similar elements in FIG. 6 bear like reference numerals. Also, dashed lined boxes are optional features on more advanced SoCs. In FIG. 12, an interconnect unit(s) 1202 is coupled to: an application processor 1210 which includes a set of one or more cores 602A-N, which include cache units 604A-N, and shared cache unit(s) 606; a system agent unit 610; a bus controller unit(s) 616; an integrated memory controller unit(s) 614; a set or one or more coprocessors 1220 which may include integrated graphics logic, an image processor, an audio processor, and a video processor; an static random access memory (SRAM) unit 1230; a direct memory access (DMA) unit 1232; and a display unit 1240 for coupling to one or more external displays. In one embodiment, the coprocessor(s) 1220 include a special-purpose processor, such as, for example, a network or communication processor, compression engine, GPGPU, a high-throughput MIC processor, embedded processor, or the like

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 830 illustrated in FIG. 8, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high-level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

### FURTHER EXAMPLES

Example 1 provides an exemplary system for processing data flow array instructions, the system comprising: a data flow array, which includes a plurality of processing elements; a decoder to receive a data flow array instruction and generate a set of microinstructions based on the data flow array instruction; a reservation station to receive and dispatch each microinstruction in the set of microinstructions, wherein the set of microinstructions includes a configuration microinstruction for configuring the data flow array for processing the data flow array instruction; and a configuration watcher to receive the configuration microinstruction and to add a configuration identifier and a set of parameters of the configuration microinstruction to a configuration queue for the data flow array, wherein the data flow array is to configure the plurality of processing elements based on configuration information associated with the configuration identifier and the set of parameters.

Example 2 provides the substance of the exemplary system of Example 1, wherein configuring the plurality of processing elements includes setting an operation to be performed by each of the plurality of processing elements and configuring a set of routing channels between processing elements such that an output from a first processing element in the plurality of processing elements is an input to a second processing element in the plurality of processing elements.

Example 3 provides the substance of the exemplary system of Example 2, wherein the set of microinstructions further includes a set of input microinstructions, which indicate a set of input operands for the data flow array instruction, and a set of output microinstructions, which indicate a set of output operands for the data flow array instruction.

Example 4 provides the substance of the exemplary system of Example 3, further comprising: an input watcher to receive the set of input microinstructions and to add the set of input operands to input queues for the data flow array, wherein the data flow array is to retrieve the input operands from the input queues and perform corresponding operations of the plurality of processing elements to generate outputs of the data flow array that are added to output queues.

Example 5 provides the substance of the exemplary system of Example 4, further comprising: an output watcher to receive the set of output microinstructions and to add the set of output operands to a write queue for the data flow array, wherein the data flow array is to generate a set of write instructions for writing the outputs from the output queues to the set of output operands from the write queue.

Example 6 provides the substance of the exemplary system of Example 5, wherein the data flow array is to generate and transmit an early warning signal to the reservation station to indicate to the reservation station that the outputs will be written to the set of output operands within a specified time interval, and the reservation station is to preemptively dispatch an instruction in response to the early warning signal.

Example 7 provides the substance of the exemplary system of Example 6, further comprising: an optimizer to receive software code and to generate the data flow array instruction, a data flow array definition describing the set of microinstructions, and configuration information for configuring the set of processing elements associated with the configuration identifier based on a determined pattern in the software code, wherein the configuration information indicates the operations to be performed by each of the plurality of processing elements and the set of routing channels between processing elements.

Example 8 provides an exemplary method for processing data flow array instructions by a processing system, the method comprising: generating, by a decoder of the processing system, a set of microinstructions based on a received data flow array instruction; dispatching, by a reservation station of the processing system, each microinstruction in the set of microinstructions, wherein the set of microinstructions includes a configuration microinstruction for configuring a data flow array for processing the data flow array instruction; adding, by a configuration watcher of the processing system, a configuration identifier and a set of parameters of the configuration microinstruction to a configuration queue for the data flow array; and configuring, by the data flow array, a plurality of processing elements of the data flow array based on configuration information associated with the configuration identifier and the set of parameters.

Example 9 provides the substance of the exemplary method of Example 8, wherein configuring the plurality of processing elements includes setting an operation to be performed by each of the plurality of processing elements and configuring a set of routing channels between processing elements such that an output from a first processing element in the plurality of processing elements is an input to a second processing element in the plurality of processing elements.

Example 10 provides the substance of the exemplary method of Example 9, wherein the set of microinstructions further includes a set of input microinstructions, which indicate a set of input operands for the data flow array instruction, and a set of output microinstructions, which indicate a set of output operands for the data flow array instruction.

Example 11 provides the substance of the exemplary method of Example 10, further comprising: adding, by an input watcher of the processing system in response to the set of input microinstructions, the set of input operands to input queues for the data flow array; and processing, by the data flow array, the input operands from the input queues, including performing the operations of the plurality of processing elements, to generate outputs of the data flow array that are added to output queues.

Example 12 provides the substance of the exemplary method of Example 11, further comprising: adding, by an output watcher of the processing system in response to the set of output microinstructions, references to the set of output operands to a write queue for the data flow array; and generating, by the write queue, a set of write instructions for writing the outputs from the output queues to the set of output operands from the write queue.

Example 13 provides the substance of the exemplary method of Example 12, further comprising: transmitting, by the data flow array, an early warning signal to the reservation station to indicate to the reservation station that the outputs will be written to the set of output operands within a specified time interval; and dispatching, by the reservation station in response to receipt of the early warning signal, a subsequent instruction that utilizes at least one operand in the set of output operands.

Example 14 provides the substance of the exemplary method of Example 13, further comprising: generating, by an optimizer of the processing system based on received software code, the data flow array instruction, including a data flow array definition describing the set of microinstructions and configuration information for configuring the set of processing elements associated with the configuration identifier, wherein the configuration information indicates the operations to be performed by each of the plurality of processing elements and the set of routing channels between processing elements.

Example 15 provides an exemplary non-transitory computer readable medium that stores instructions, which when executed by a processor, cause the processor to: generate a set of microinstructions based on a received data flow array instruction; dispatch each microinstruction in the set of microinstructions, wherein the set of microinstructions includes a configuration microinstruction for configuring a data flow array for processing the data flow array instruction; add a configuration identifier and a set of parameters of the configuration microinstruction to a configuration queue for the data flow array; and configure a plurality of processing elements of the data flow array based on configuration information associated with the configuration identifier and the set of parameters.

Example 16 provides the substance of the exemplary non-transitory computer readable medium of Example 15, wherein configuring the plurality of processing elements includes setting an operation to be performed by each of the plurality of processing elements and configuring a set of routing channels between processing elements such that an output from a first processing element in the plurality of processing elements is an input to a second processing element in the plurality of processing elements.

Example 17 provides the substance of the exemplary non-transitory computer readable medium of Example 16, wherein the set of microinstructions further includes a set of input microinstructions, which indicate a set of input operands for the data flow array instruction, and a set of output microinstructions, which indicate a set of output operands for the data flow array instruction.

Example 18 provides the substance of the exemplary non-transitory computer readable medium of Example 17, wherein the instructions further cause the processor to: add, based on the set of input microinstructions, the set of input operands to input queues for the data flow array; and process the input operands from the input queues, including performing the operations of the plurality of processing elements, to generate outputs of the data flow array that are added to output queues.

Example 19 provides the substance of the exemplary non-transitory computer readable medium of Example 18, wherein the instructions further cause the processor to: add, based on the set of output microinstructions, references to the set of output operands to a write queue for the data flow array; and generate a set of write instructions for writing the outputs from the output queues to the set of output operands from the write queue.

Example 20 provides the substance of the exemplary non-transitory computer readable medium of Example 19, wherein the instructions further cause the processor to: transmit an early warning signal to indicate that the outputs will be written to the set of output operands within a specified time interval; and dispatch, in response to receipt of the early warning signal, a subsequent instruction that utilizes at least one operand in the set of output operands.

What is claimed is:

1. A system for processing data flow array instructions, the system comprising:
a data flow array, which includes a plurality of processing elements;
a decoder to receive a data flow array instruction and generate a set of microinstructions based on the data flow array instruction;
a reservation station to receive and dispatch each microinstruction in the set of microinstructions, wherein the set of microinstructions includes a configuration microinstruction for configuring the data flow array for processing the data flow array instruction; and
a configuration watcher to receive the configuration microinstruction and to add a configuration identifier and a set of parameters of the configuration microinstruction to a configuration queue for the data flow array,
wherein the data flow array is to configure the plurality of processing elements based on configuration information associated with the configuration identifier and the set of parameters.

2. The system of claim 1, wherein configuring the plurality of processing elements includes setting an operation to be performed by each of the plurality of processing elements and configuring a set of routing channels between processing elements such that an output from a first processing element in the plurality of processing elements is an input to a second processing element in the plurality of processing elements.

3. The system of claim 2, wherein the set of microinstructions further includes a set of input microinstructions, which indicate a set of input operands for the data flow array instruction, and a set of output microinstructions, which indicate a set of output operands for the data flow array instruction.

4. The system of claim 3, further comprising:
an input watcher to receive the set of input microinstructions and to add the set of input operands to input queues for the data flow array,
wherein the data flow array is to retrieve the input operands from the input queues and perform corresponding operations of the plurality of processing elements to generate outputs of the data flow array that are added to output queues.

5. The system of claim 4, further comprising:
an output watcher to receive the set of output microinstructions and to add the set of output operands to a write queue for the data flow array,
wherein the data flow array is to generate a set of write instructions for writing the outputs from the output queues to the set of output operands from the write queue.

6. The system of claim 5, wherein the data flow array is to generate and transmit an early warning signal to the reservation station to indicate to the reservation station that the outputs will be written to the set of output operands within a specified time interval, and the reservation station is to preemptively dispatch an instruction in response to the early warning signal.

7. The system of claim 6, further comprising:
an optimizer to receive software code and to generate the data flow array instruction, a data flow array definition describing the set of microinstructions, and configuration information for configuring the set of processing elements associated with the configuration identifier based on a determined pattern in the software code,
wherein the configuration information indicates the operations to be performed by each of the plurality of processing elements and the set of routing channels between processing elements.

8. A method for processing data flow array instructions by a processing system, the method comprising:
generating, by a decoder of the processing system, a set of microinstructions based on a received data flow array instruction;
dispatching, by a reservation station of the processing system, each microinstruction in the set of microinstructions, wherein the set of microinstructions includes a configuration microinstruction for configuring a data flow array for processing the data flow array instruction;
adding, by a configuration watcher of the processing system, a configuration identifier and a set of parameters of the configuration microinstruction to a configuration queue for the data flow array; and
configuring, by the data flow array, a plurality of processing elements of the data flow array based on configuration information associated with the configuration identifier and the set of parameters.

9. The method of claim 8, wherein configuring the plurality of processing elements includes setting an operation to be performed by each of the plurality of processing elements and configuring a set of routing channels between processing elements such that an output from a first processing element in the plurality of processing elements is an input to a second processing element in the plurality of processing elements.

10. The method of claim 9, wherein the set of microinstructions further includes a set of input microinstructions, which indicate a set of input operands for the data flow array instruction, and a set of output microinstructions, which indicate a set of output operands for the data flow array instruction.

11. The method of claim 10, further comprising:
adding, by an input watcher of the processing system in response to the set of input microinstructions, the set of input operands to input queues for the data flow array; and
processing, by the data flow array, the input operands from the input queues, including performing the operations of the plurality of processing elements, to generate outputs of the data flow array that are added to output queues.

12. The method of claim 11, further comprising:
adding, by an output watcher of the processing system in response to the set of output microinstructions, references to the set of output operands to a write queue for the data flow array; and
generating, by the write queue, a set of write instructions for writing the outputs from the output queues to the set of output operands from the write queue.

13. The method of claim 12, further comprising:
transmitting, by the data flow array, an early warning signal to the reservation station to indicate to the reservation station that the outputs will be written to the set of output operands within a specified time interval; and
dispatching, by the reservation station in response to receipt of the early warning signal, a subsequent instruction that utilizes at least one operand in the set of output operands.

14. The method of claim 13, further comprising:
generating, by an optimizer of the processing system based on received software code, the data flow array instruction, including a data flow array definition describing the set of microinstructions and configuration information for configuring the set of processing elements associated with the configuration identifier,
wherein the configuration information indicates the operations to be performed by each of the plurality of processing elements and the set of routing channels between processing elements.

15. A non-transitory computer readable medium that stores instructions, which when executed by a processor, cause the processor to:
generate a set of microinstructions based on a received data flow array instruction;
dispatch each microinstruction in the set of microinstructions, wherein the set of microinstructions includes a configuration microinstruction for configuring a data flow array for processing the data flow array instruction;
add a configuration identifier and a set of parameters of the configuration microinstruction to a configuration queue for the data flow array; and
configure a plurality of processing elements of the data flow array based on configuration information associated with the configuration identifier and the set of parameters.

16. The non-transitory computer readable medium of claim 15, wherein configuring the plurality of processing elements includes setting an operation to be performed by each of the plurality of processing elements and configuring a set of routing channels between processing elements such that an output from a first processing element in the plurality of processing elements is an input to a second processing element in the plurality of processing elements.

17. The non-transitory computer readable medium of claim 16, wherein the set of microinstructions further includes a set of input microinstructions, which indicate a set of input operands for the data flow array instruction, and a set of output microinstructions, which indicate a set of output operands for the data flow array instruction.

18. The non-transitory computer readable medium of claim 17, wherein the instructions further cause the processor to:
add, based on the set of input microinstructions, the set of input operands to input queues for the data flow array; and
process the input operands from the input queues, including performing the operations of the plurality of processing elements, to generate outputs of the data flow array that are added to output queues.

19. The non-transitory computer readable medium of claim 18, wherein the instructions further cause the processor to:
add, based on the set of output microinstructions, references to the set of output operands to a write queue for the data flow array; and
generate a set of write instructions for writing the outputs from the output queues to the set of output operands from the write queue.

20. The non-transitory computer readable medium of claim 19, wherein the instructions further cause the processor to:
transmit an early warning signal to indicate that the outputs will be written to the set of output operands within a specified time interval; and
dispatch, in response to receipt of the early warning signal, a subsequent instruction that utilizes at least one operand in the set of output operands.
